(19) United States
(12) Patent Application Publication
(10) Pub. No.: US 2020/0029191 A1
(43) Pub. Date: Jan. 23, 2020

(54) METHOD AND APPARATUS FOR SETTING A SERVER BRIDGE IN AN AUTONOMOUS DRIVING SYSTEM

(71) Applicant: LG ELECTRONICS INC., Seoul (KR)

(72) Inventor: Soryoung KIM, Seoul (KR)

(21) Appl. No.: 16/588,369

(22) Filed: Sep. 30, 2019

(30) Foreign Application Priority Data
Aug. 15, 2019 (KR) 10-2019-0099977

(51) Int. Cl. H04W 4/44; H04L 29/08; H04W 76/10; H04W 36/00; H04W 36/08

(52) U.S. Cl. CPC H04W 4/44; H04L 67/10; H04W 36/08; H04W 76/10; H04W 36/0016; H04L 67/12

(57) ABSTRACT

Provided is a method of setting a server bridge of a first server in an autonomous driving system. The method includes establishing a communication connection with a vehicle in coverage of a first base station, through the first base station, receiving set information of the vehicle and a request message for generating the server bridge from the vehicle, setting as a server for receiving first data from the vehicle, determining an expected time for processing the first data, based on the set information, generating the server bridge based on the set information and the expected time, and transmitting address information of servers constituting the server bridge to the vehicle using a transceiver, so that the server bridge may distributed process the first data.

### CROSS-REFERENCE TO RELATED APPLICATION

This application claims the benefit of Korean Patent Application No. 10-2019-0099977 filed on Aug. 15, 2019, which is incorporated by reference.

### BACKGROUND OF THE INVENTION

### Field of the Invention

The present disclosure relates to an autonomous driving system and, more particularly, to a method and apparatus for setting a server bridge, capable of distributed processing data of a vehicle.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

The present disclosure provides a method of setting a server bridge, capable of distributed processing data of a vehicle.

The present disclosure also provides a method of setting a role related to data processing for servers constituting a server bridge.

The objects of the present disclosure are not limited to the objects described above and other objects can be clearly understood by those skilled in the art from the following description.

In an aspect, a method of setting a server bridge of a vehicle in an autonomous driving system includes establishing a communication connection with a first server through a first base station; transmitting set information of the vehicle and a request message for generating the server bridge to the first server; and receiving address information of servers constituting the server bridge from the first server, wherein the server bridge is composed of one or more servers for distributed processing first data generated by the vehicle, and connects a server performing an uplink for the vehicle with a server performing a downlink, and the set information comprises driving path information of the vehicle and data information about a type and a size of the first data.

The method may further include transmitting the first data to the first server, wherein the first server may be set as a server for receiving the first data from the vehicle.

The method may further include establishing a communication connection with a second server, by handing over to a second base station; determining a server role of the second server, based on the server bridge; and transmitting and receiving data to and from the second server, based on the server role.

The method may further include, when the server has a role in transmitting the result value of the first data processed through the server bridge to the vehicle, transmitting a message for requesting a result value to the second server; and receiving the result value.

The method may further include, when the driving path information is reset, transmitting the driving path information and a notification message notifying that the driving path information is reset to the second server; and receiving the updated address information.

In another aspect, a method of setting a server bridge of a first server in an autonomous driving system includes establishing a communication connection with a vehicle in coverage of a first base station, through the first base station; receiving set information of the vehicle and a request message for generating the server bridge from the vehicle; setting as a server for receiving first data from the vehicle; determining an expected time for processing the first data, based on set information; generating the server bridge, based on the set information and the expected time; and transmitting address information of servers constituting the server bridge to the vehicle, wherein the server bridge is composed of one or more servers for distributed processing the first data, and connects a server performing an uplink for the vehicle with a server performing a downlink, and the set information comprises driving path information of the vehicle and data information on a type and a size of the first data.

The method may further include transmitting the address information to a second server that is a next component of the first server based on the server bridge, wherein the second server may set a server role based on the address information.

The method may further include receiving the first data from the vehicle; structuring the first data; and transmitting the first data through the first base station to the second server, wherein the structuring of the first data may be to use a map reduce framework.

When the second server has a role in transmitting a result value of the first data processed through the server bridge to the vehicle, the result value may be transmitted through the second server to the vehicle.

When the driving path information is reset, the driving path information and a notification message notifying that the driving path information is reset may be received through the second server, the server bridge may be regenerated based on the driving path information, the address information may be updated based on the server bridge, and the address information may be transmitted to the vehicle.

Furthermore, the first server or the second server may be a Mobile Edge Computing (MEC) server.

The server bridge may include an uplink (UL) server for receiving the first data from the vehicle, a processing server for processing the first data, or a downlink (DL) server for transmitting the result value of the first data.

The reset server bridge may be based on a hardware specification or a processing speed of the server constituting the reset server bridge.

Each of the UL server and the processing server may perform a role of a mapper for using the map reduce framework, and the DL server may perform a role of a reducer for using the map reduce framework.

In a further aspect, a first server for performing a method of setting a server bridge in an autonomous driving system may include a communication module; a memory; and a processor, wherein the processor establishes a communication connection with a vehicle in coverage of a first base station through the first base station using the communication module, receives set information of the vehicle and a request message for generating the server bridge from the vehicle, sets as a server for receiving first data from the vehicle, determines an expected time for processing the first data based on the set information, generates the server bridge based on the set information and the expected time, and transmits address information of servers constituting the server bridge to the vehicle using the communication module, wherein the server bridge is composed of one or more servers for distributed processing the first data, and connects a server performing an uplink for the vehicle with a server performing a downlink, and the set information comprises driving path information of the vehicle and data information on a type and a size of the first data.

The present disclosure has an advantage in that a vehicle in an autonomous driving system can distributed processing data through servers constituting a server bridge.

The present disclosure also has an advantage in that it is possible to set a role related to data processing for servers constituting a server bridge.

The effects of the present disclosure are not limited to the effects described above and other effects can be clearly understood by those skilled in the art from the following description.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram illustrating a usage scenario of a user according to an embodiment of the present disclosure.

FIG. 10 illustrates a V2X communication to which the present disclosure is applicable.

FIGS. 11A and 11B illustrate a resource allocation method at a sidelink where V2X is used.

FIG. 12 illustrates architecture of a Mobile Edge Computing (MEC) server applicable to the present disclosure.

FIG. 13 illustrates a map reduce framework to which the present disclosure is applicable.

FIG. 14 is an embodiment to which the present disclosure is applicable.

FIG. 15 illustrates an initial server access to which the present disclosure is applicable.

FIG. 16 illustrates an operation through a DL server to which the present disclosure is applicable.

FIG. 17 illustrates an operation of a vehicle to which the present disclosure is applicable.

FIG. 18 illustrates an operation of a server to which the present disclosure is applicable.

FIG. 19 is a diagram showing the configuration of the server to which the present disclosure is applied.

The accompanying drawings, which are included to provide a further understanding of the invention and are incorporated in a part of this specification, illustrate embodiments of the invention and together with the description serve to explain the principles of the invention

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

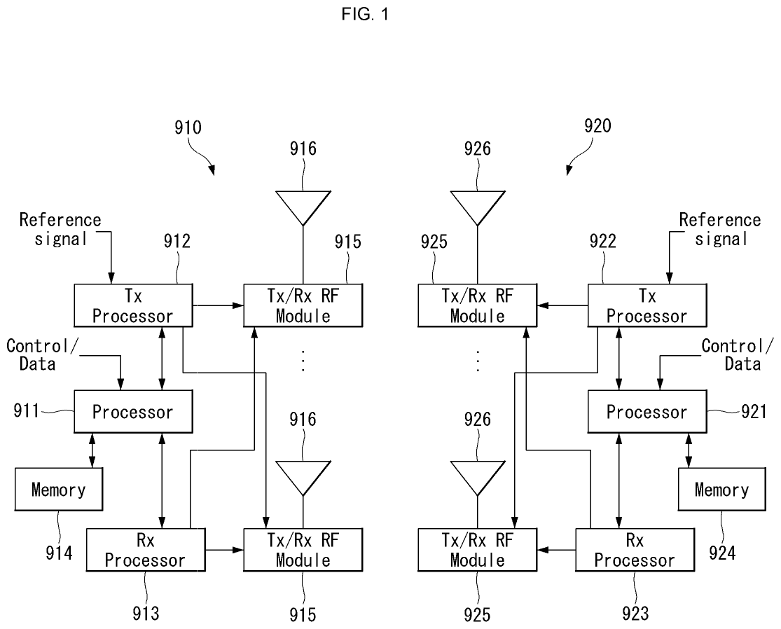

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

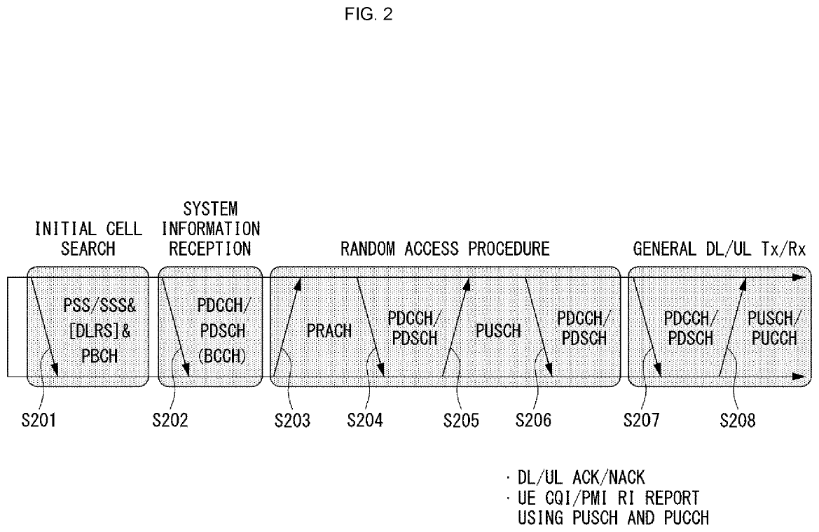

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

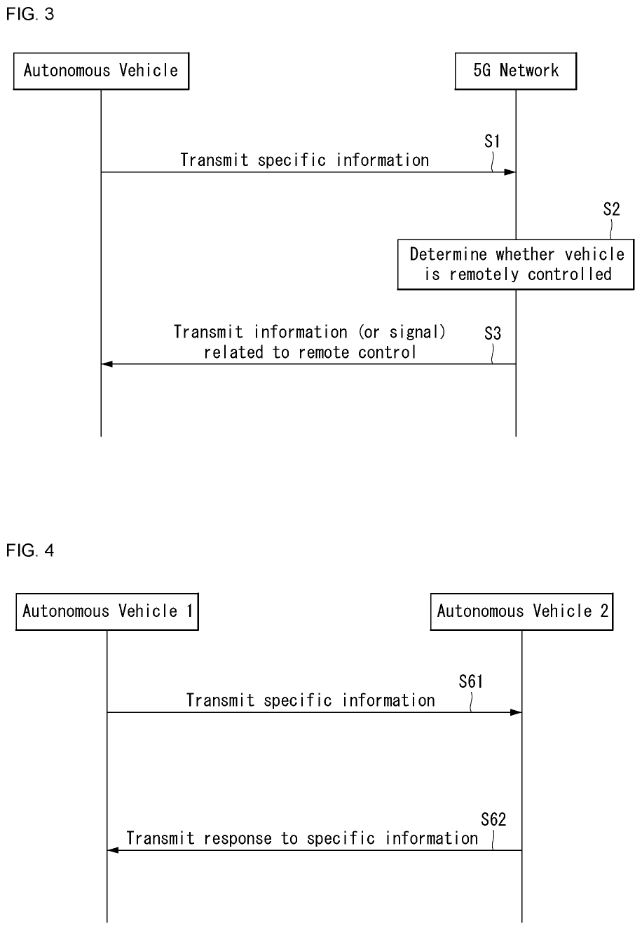

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

Driving

(1) Exterior of Vehicle

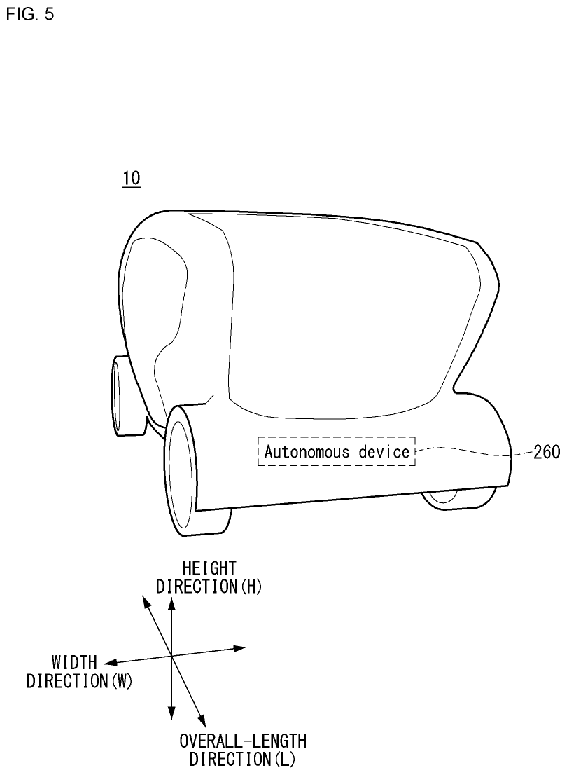

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

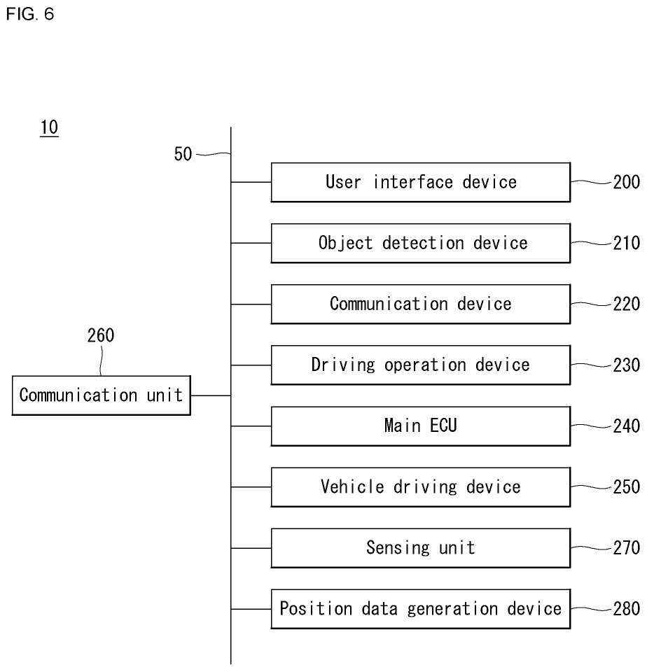

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

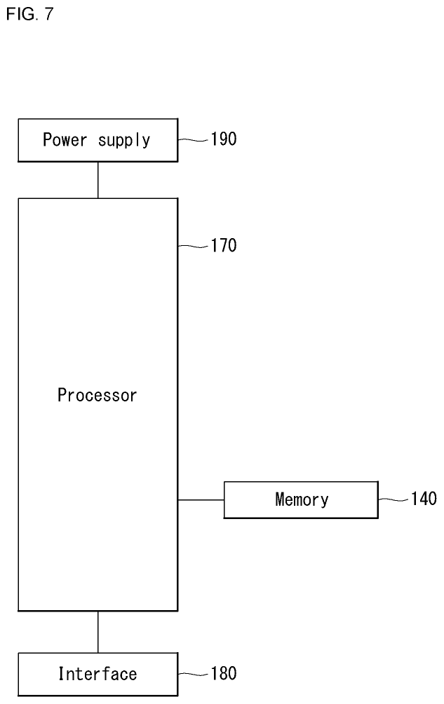

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

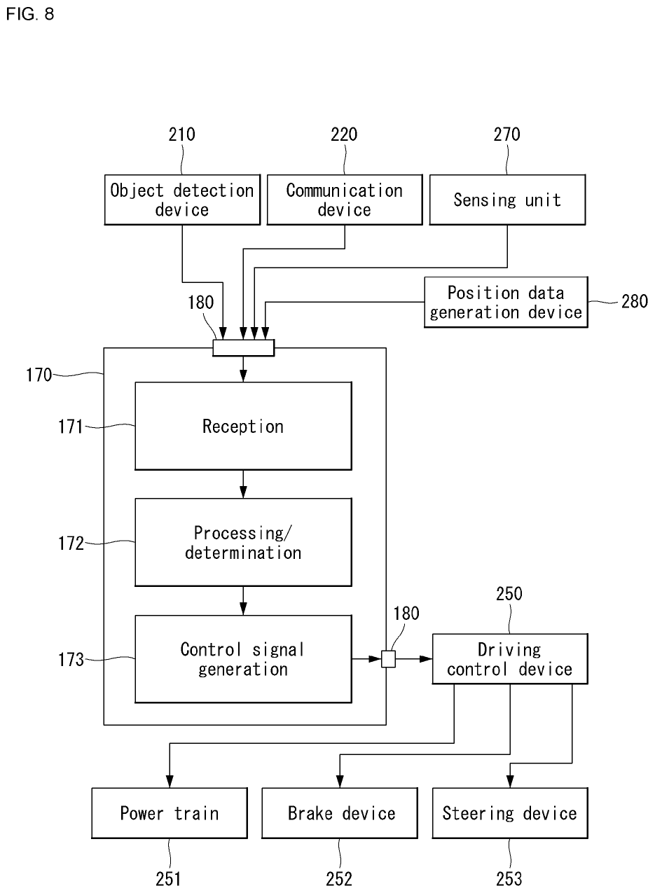

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenarios

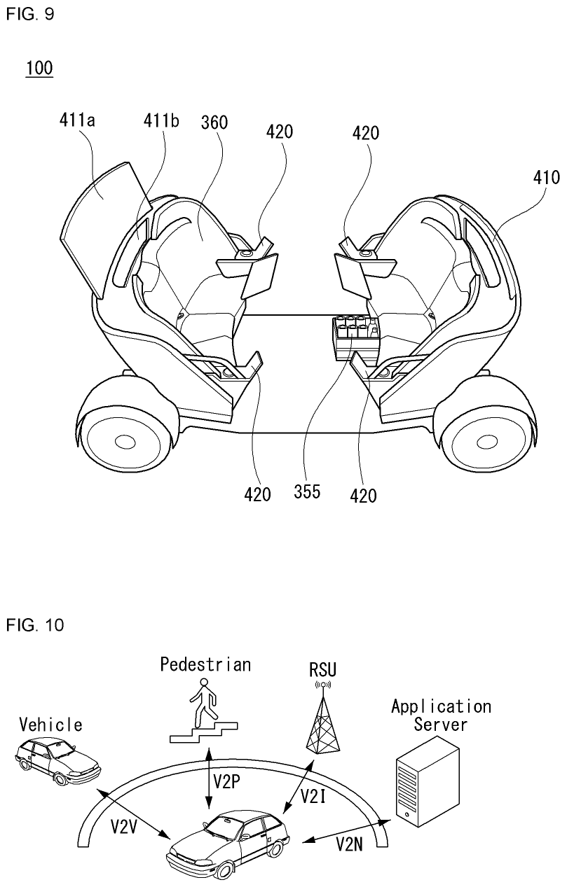

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

FIG. 10 illustrates a V2X communication to which the present disclosure is applicable.

The V2X communication includes V2V (Vehicle-to-Vehicle) communication referring to communication between vehicles, V2I (Vehicle to Infrastructure) communication referring to communication between a vehicle and an eNB or a RSU (Road Side Unit), V2P (Vehicle-to-Pedestrian) communication between a vehicle and an UE carried by an individual (pedestrian, bicyclist, vehicle driver or passenger), V2N (vehicle-to-network) communication, and communication between a vehicle and all entities.

The V2X communication may represent the same meaning as a V2X sidelink or NR V2X, or may represent a broader meaning including the V2X sidelink or NR V2X.

The V2X communication is applicable to various services, for example, a forward collision warning, an automated parking system, a cooperative adaptive cruise control (CACC), a control loss warning, a tailback warning, a transportation vulnerable safety warning, an emergency vehicle warning, a speed warning when driving on a curved road, and a traffic flow control.

The V2X communication may be provided through a PC5 interface and/or a Uu interface. In this case, specific network entities for supporting communication between the vehicle and all entities may be provided in a wireless communication system that supports the V2X communication. For example, the network entities may include a BS (eNB), a RSU (road side unit), a UE, an application server (e.g. traffic safety server), etc.

Furthermore, the UE performing the V2X communication may mean a general handheld UE, a vehicle UE (V-UE), a pedestrian UE, a BS type (eNB type) RSU, a UE type RSU, a robot having a communication module, and the like.

The V2X communication may be directly performed between the UEs, or may be performed through the network entity (entities). The V2X operating mode may be classified according to the performing method of the V2X communication.

The V2X communication is required to support the pseudonymity and privacy of the UE when using the V2X application, so that an operator or a third party may do not track an UE identifier in a region where the V2X is supported.

Terms which are frequently used in the V2X communication are defined as follows.
RSU (Road Side Unit): RSU is a V2X serviceable device that can transmit/receive a signal to/from a moving vehicle using V2I service. Furthermore, the RSU is a fixed infrastructure entity supporting the V2X application, and may exchange a message with another entity supporting the V2X application. The RSU is a term that is frequently used in an existing ITS specification. The reason why this term is applied to a 3GPP specification is because this makes it easier to read documents in the ITS industry. The RSU is a logical entity that couples a V2X application logic to the function of a BS (BS-type RSU) or a UE (UE-type RSU).
V2I service: this is one type of the V2X service, and has at one side the vehicle and at the other side the entity belonging to the infrastructure.
V2P service: this is one type of the V2X service, and has at one side a vehicle and at the other side a device carried by an individual (e.g. handheld UE carried by a pedestrian, a bicyclist, a driver or a fellow passenger).
V2X service: this is the 3GPP communication service type related to a transmission or reception device in the vehicle.
V2X enabled UE: this is the UE supporting the V2X service.
V2V service: this is a type of V2X service, and communicates at both sides thereof with vehicles.
V2V communication range: a direct communication range between two vehicles participating in the V2V service.

As described above, the V2X application referred to as the V2X (Vehicle-to-Everything) may have four types, namely, (1) vehicle to vehicle (V2V), (2) vehicle to infrastructure (V2I), (3) vehicle to network (V2N), and (4) vehicle to pedestrian (V2P).

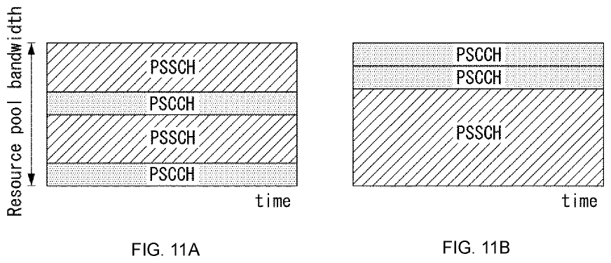

FIGS. 11A and 11B illustrate a resource allocation method at a sidelink where V2X is used.

At the sidelink, different physical sidelink control channels (PSCCH) may be allocated in a frequency domain to be spaced apart from each other, and different physical sidelink shared channels (PSSCH) may be allocated to be spaced apart from each other. Alternatively, the different PSCCHs may be continuously allocated in the frequency domain, and the PSSCHs may also be continuously allocated in the frequency domain.

NR V2X

In order to extend a 3GPP platform to an automotive industry during 3GPP release 14 and 15, support for the V2V and V2X services in LTE was introduced.

Requirements for supporting an enhanced V2X use case are mainly divided into four use case groups.

(1) Vehicle Platooning can dynamically form a platoon in which vehicles move together. All vehicles of the platoon obtain information from a lead vehicle to manage this platoon. This information allows the vehicles to run more harmoniously than a normal direction, to move together in the same direction.

(2) Extended sensors may exchange raw or processed data collected through a local sensor or a live video image in a vehicle, a road site unit, a pedestrian device and a V2X application server. The vehicle can recognize an environment beyond a level sensed by the vehicle's sensor, and can detect road conditions more broadly and collectively. A high data transmission rate is one of main features.

(3) Advanced driving enables semi-automatic or full-automatic driving. Each vehicle and/or RSU shares self-recognition data obtained from the local sensor with a proximate vehicle, and allows the vehicle to synchronize or coordinate a trajectory or a maneuver. Each vehicle shares a driving intention with a proximate driving vehicle.

(4) Remote driving allows a remote driver or a V2X application to drive a remote vehicle which is in dangerous conditions or for a passenger who cannot drive by himself or herself. If fluctuations are limited and a path is predictable, such as public transportation, it is possible to use cloud-computing based driving. High reliability and low waiting time are key requirements.

The above-described 5G communication technology may be applied in combination with methods proposed in the present disclosure that will be described later, or may be supplemented to specify or clarify the technical features of the methods proposed in the present disclosure.

Hereinafter, various embodiments of the present disclosure will be described in detail with reference to the accompanying drawings.

MEC Server

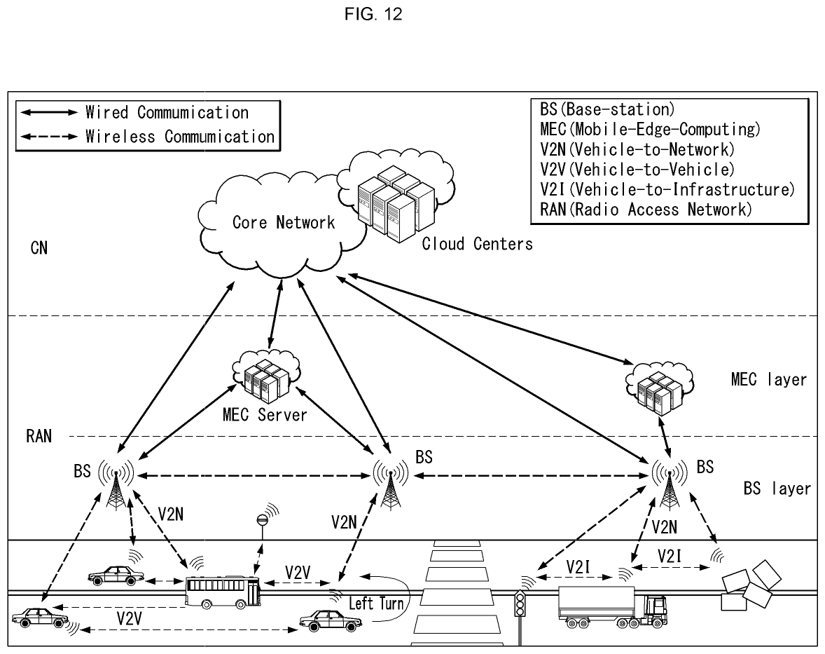

FIG. 12 illustrates architecture of a mobile edge computing (MEC) server applicable to the present disclosure.

The MEC server not only can perform a role of a normal server but also can provide flexible vehicle related services and allow efficient network operation by being connected to a base station (BS) near a road in a radio access network (RAN). Particularly, a network-slicing and traffic scheduling policy supported by the MEC server can aid in network optimization.

In the architecture, MEC servers may be integrated in the RAN and located at an SI-user plane interface (for example, between a core network and a BS) in a 3GPP system. Each MEC server can be regarded as an independent network element and does not affect connection of existing wireless networks. An independent MEC server is connected to a BS through a dedicated communication network and can provide specific services to various end-users located in the corresponding cell. Such an MEC server and a cloud server are connected through Internet-backbone and can share information. Although the Internet-backbone is connected in a wired manner in the architecture, the Internet-backbone may be connected in a wireless manner according to a configuration method.

The MEC server is independently operated and can control a plurality of BSs. Particularly, the MEC server performs services for autonomous vehicles, an application operation such as a virtual machine (VM), and an operation at a mobile network edge based on a virtualization platform.

A base station (BS) is connected to MEC servers and a core network to facilitate flexible user traffic scheduling required to execute provided services.

The MEC server and a 3G radio network controller (RNC) are located at similar network levels but the following differences are present therebetween.
Dozens, hundreds or more of BSs can be controlled by the RNC, and transmission delay occurrence increases as the number of configured BSs increases. However, the MEC server directly interacts with less than 10 BSs in general and thus can prevent excessive transmission delay.
In addition, since the MEC server in the architecture provides efficient communication between a BS and the core network and also permits previous communication between BSs and between a BS and the core network, the MEC server can be used in the corresponding network.
When large-capacity user traffic is generated in a specific cell, the MEC server can perform task offloading and cooperation processing on the basis of an interface between neighboring BSs.
The RNC provides only a fixed function for wireless network control, whereas the MEC server has an open operation environment based on software and thus new services of application providers can be easily provided.

The architecture including the MEC server can provide the following advantages.
Service waiting time reduction: A data reciprocating time is reduced and a service provision speed is high because services are performed near end-users.
Flexible service provision: MEC applications and virtual network functions (VNF) provide flexibility and geographical distribution in service environments. Various applications and network functions can be programmed and only a specific user group can be selected or compiling only for the specific user group can be performed using such a virtualization technique. Accordingly, provided services can be applied more closely to user requirements.
Cooperation between BSs: The MEC server has central control capability and can minimize interaction between BSs. This can simplify a process for executing basic functions of a network such as handover between cells. Such a function can be useful in automated vehicle & highway systems having many users.
Minimization of congestion: Terminals on roads periodically generate a large amount of small packets in automated vehicle & highway systems. The MEC server in RNC can reduce the amount of traffic that needs to be transmitted to a core network by performing a specific service and thus decrease processing loads of a cloud in a centralized cloud system and minimize network congestion.
Reduction of operation expenses: The MEC server integrates a network control function and individual services and thus can increase profitability of mobile network operators (MNOs) and facilitates rapid and efficient maintenance and upgrade through installation density adjustment.

Map Reduce Framework

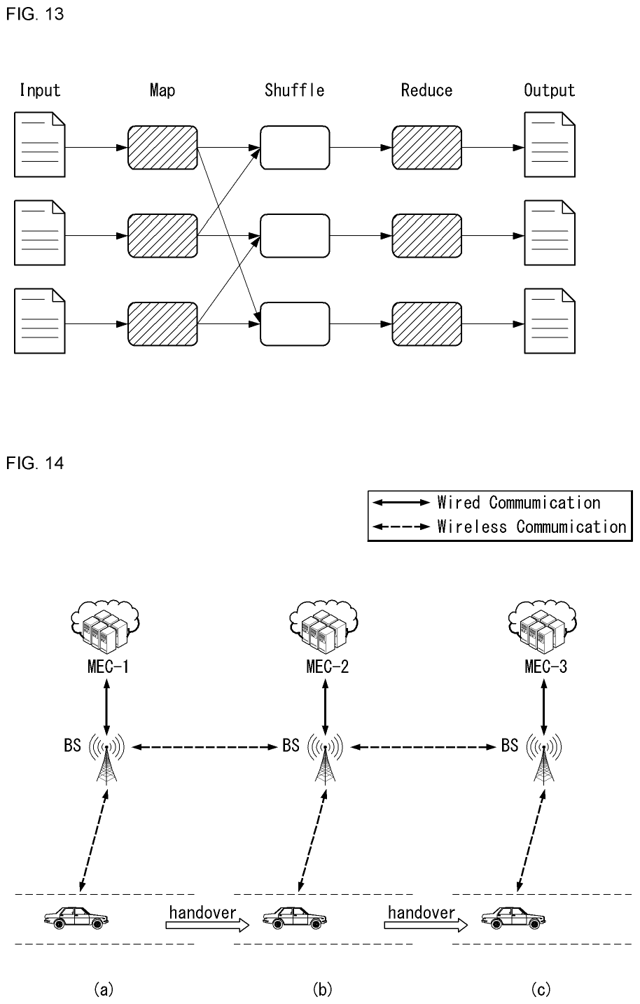

FIG. 13 illustrates a map reduce framework to which the present disclosure is applicable.

The map reduce is a distributed programming model for massive data processing. The map reduce is performed by dividing the procedure into a map phase and a reduce phase.
Map phase: a mapper may structure unstructured data. For example, if music files need to be categorized by song genre, the mapper generates the pair of key and value in a music file data set. Here, the key may be the song genre, and the value may be the music file. If the data set is provided to the mapper, the data set may be structured to have the key and value pair. The map function may process the data, and may be made up of several small data units.
Reduce Phase: a shuffle phase and a reduce phase are collectively called the reduce phase. A reducer has an output value of the mapper as an input value, and generates a final output value according to a programmer's setting. The reducer acquires all key and value pairs from the mapper, and checks correlation therebetween. All values correlated with one key are acquired, and then are provided as the output value having the key and value pair.

If the size of data transmitted to the MEC server is a large capacity, the MEC server may not normally process this data due to the lack of resource. In order to purchase and maintain the MEC server that can process a large-capacity data, a lot of cost is incurred. Furthermore, since the MEC server is a region based server, it has a problem in that the vehicle exceeds coverage of the MEC server requesting the data processing, if it takes a long time to process the data.

According to the present disclosure, when the vehicle is connected to the MEC server, the vehicle transmits set information, and the MEC server determines whether data is distributed-processed or not, data processing time, and the like, based on the received set information. If the data may be distributed-processed, a server bridge on a driving path may be generated until the data processing time, and the server bridge may perform the operation of the above-described map reduce framework. A main role is allocated to the server of each server bridge depending on a position (e.g. up link/processing/down link), the data is distributed-processed through the server of the server bridge, and the server information about the data processing role of the MEC server is transmitted to the vehicle. The vehicle transmits the data to the MEC server and receives a result, according to the received server information.

Therefore, the present disclosure can ensure to transmit the processed result to the vehicle, and can reduce cost of connecting it to the MEC server, due to the handover of the vehicle, for the data requiring a long processing time. Furthermore, in the case of requiring the massive data processing, it is possible to secure a stable processing speed and to overcome limitations of using a single MEC server, by distributed-processing data, through the MEC server, on the basis of the moving path of the vehicle.

FIG. 14 is an embodiment to which the present disclosure is applicable.

The vehicle may be connected to a base station located on the driving path, and thereby may be connected to the MEC server. In the case of exceeding the coverage of the connected base station, the vehicle may perform the handover, and thereby may be connected to the base station and connected to another MEC server.

Referring to (a) of FIG. 14, the vehicle is connected to a MEC-1 server to transmit the set information of the vehicle to the MEC-1 server. The set information includes the identifier of the vehicle, position information, a driving path, the type and size of transmission data, information about a required function, and information about a link server. Here, the link-server information is address information of the server included in the server bridge, and a main role is allocated depending on a position. For example, the UL (uplink), the processing, and the DL (downlink) may be allocated as the main role.

According to the link-server information, the server bridge is generated. If the link-server information is not included in the set information of the vehicle, the MEC-1 server receiving the message indicating that the vehicle requests the generation of the server bridge may generate the server bridge, and the link-server information of the server bridge may be transmitted to the vehicle. The request message may be transmitted together with the set information.

Referring to (b) of FIG. 14, when the vehicle is handed over to be connected to the MEC-2 server, the vehicle determines whether the MEC-2 server is a DL server or not. If the MEC-2 server is not the DL server, the vehicle does not perform a data receiving operation.

Referring to (c) of FIG. 14, if the continuously driving vehicle is handed over to be connected to the MEC-3 server and it is determined that the MEC-3 server is the DL server, the vehicle may receive the data processing result from the MEC-3 server.

The driving path of the vehicle that is driving may be changed. In this case, the initially set server bridge should be updated. Therefore, the vehicle that is changed in the set driving path notifies the currently connected MEC server of the changed driving path and a change in driving path. The currently connected MEC server receiving this notification regenerates the link-server information, according to the changed driving path. Data processed by the server included in the existing server bridge may be transmitted to the server of the new server bridge according to the regenerated link-server information, and the distributed-processing of the data may be maintained.

Operation of MEC Server According to Link-Server Information

The vehicle transmits set information through the base station to the connected MEC server. Alternatively, the MEC server may receive the link-server information from another MEC server through another base station. Depending on whether the MEC server receives the link-server information, the following operation may be performed.

(1) When the Link-Server Information is not Received:

When there is no link-server information in the set information of the vehicle and the vehicle transmits the server-bridge generation request message, the MEC server sets the corresponding server as the UL server, and transmits its own address information to the vehicle. Since the vehicle may recognize that the MEC server is set as the UL server, the vehicle transmits data to the MEC server.

(2) When the Link-Server Information is Received:

The MEC server may determine whether the MEC server is a MEC server constituting the server bridge, via the link-server information. If the MEC server is the DL server and the MEC server receives a data processing result, this may be transmitted to the vehicle.

Operation of Server Bridge According to Data Reception in UL Server

The UL server determines the expected processing time of received data. Here, if the distributed process is required, a processing type in which the timeliness of data is not guaranteed is included. The timeliness of data means that data is obtained and analyzed within a valid period

For example, the expected processing time may be determined by the product of the average processing time of data and the data size.

For example, the data processing that guarantees the timeliness may be a process for a function related to the driving safety of the vehicle such as an object-detection function. For example, the data processing that does not guarantee the timeliness may be a process for a driving-pattern learning function of the vehicle as a function requiring a certain learning time, after data collection.

The MEC server determines the expected vehicle position and the change number of the MEC server due to the handover of the vehicle on the driving path, when data processing has been completed, based on the expected processing time, the position information and the driving path of the vehicle. The MEC server determines whether to distributed process the data, depending on the expected vehicle position and the change number of the MEC server.

(1) When there is No Change in the MEC Server:

The distributed process is not performed.

(2) When the MEC Server is Changed One or More Times:

According to the driving path of the vehicle, the server bridge composed of the servers connected during the expected processing time is generated. Such a server bridge can set a main processing role for the server included in the server bridge to perform the operation of the above-described map reduce framework.

For example, the server having the mapper role may collect data, and may structure data. The server having the reducer role may have as an input value data that is processed in the server having the mapper role, and may generate a final result value.

For example, when the server bridge includes an UL server, a processing server, and a DL server, the UL server may collect data from the vehicle according to the mapper role, and the processing server may structure the data through the distributed process, and the DL server may generate the final result value and transmit it to the vehicle, by having the data as the input value, according to the reducer role.

Depending on whether the distributed process is performed or not, the MEC server may transmit the link-server information to the vehicle. The vehicle transmits the data to the UL server through the link-server information, and receives the data processing result value through the DL server.

Operation of MEC Server Due to Change in Driving Path

In the case of setting the server bridge, if the driving path of the vehicle that is driving is changed, a path change message is transmitted to the currently connected MEC server. The path change message may include the change or unchange of the path, a changed path, and link-server information. The MEC server regenerates the server bridge based on the changed driving path.

The MEC server of the server bridge receives and processes data executed in the existing server bridge according to the performance. The performance of the MEC server may be determined on the basis of a hardware specification, and may be determined on the basis of a processing speed performed at the single server and a distributed-processing speed at a plurality of servers.

For example, when the first server bridge is composed of a UL server A, a processing server B, and a DL server C, and a B/C server is changed to a D/E/F server in the regenerated server bridge,

1) If the B server performance is within the same range as the D server performance, work that is being performed in the B server is performed by the D server, and the E server is set as the DL server.

2) If the B server performance is higher than the D server performance, work that is being performed in the B server is distributed-processed by the D server and the E server, an F server is set as the DL server.

3) If the processing speed of the B server is in the same range as the distributed processing speed using the D/E/F server, work that is being performed in the B server is distributed-processed using the D/E/F server, and the F server is set as the DL server.

Unless the data processing is completed in the driving path of the vehicle, the MEC server may transmit a data processing result to the vehicle when the vehicle is connected to the network again. To this end, the existing data processing result may be stored in the cloud server.

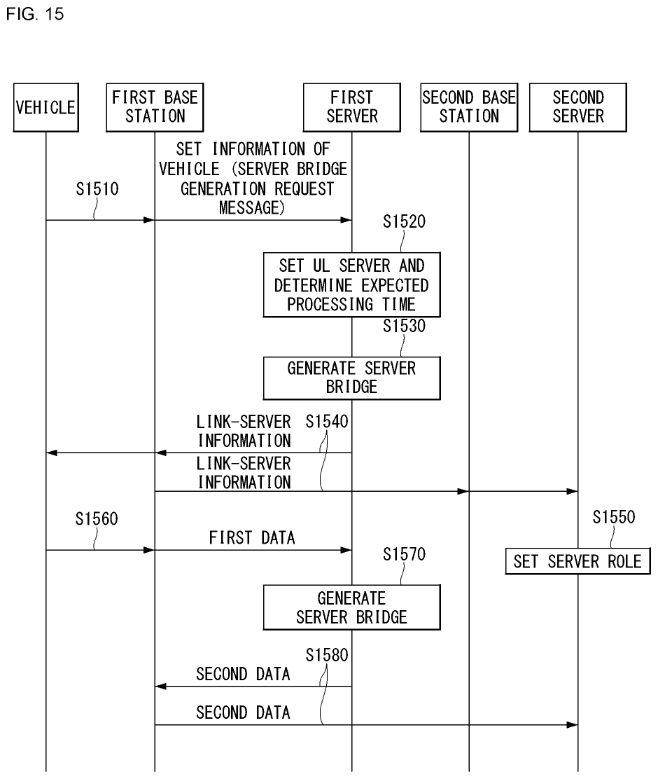

FIG. 15 illustrates an initial server access to which the present disclosure is applicable.

In FIG. 15, the vehicle may be connected through a first base station to a first server, and may be connected through a second base station to a second server. Furthermore, the first server may be connected through the first base station and the second base station to the second server. The first vehicle is in the coverage of the first base station, and is connected to the first server.

The vehicle transmits the set information of the vehicle to the first server with which a communication connection is established, at step S1510. A request message for generating the server bridge may be transmitted together.

The first server sets the corresponding server as the UL server, based on the received request message, and determines the expected processing time according to the data information in the set information, at step S1520.

The first server generates the server bridge according to the expected processing time and the driving path, at step S1530. To this end, the first server may request information of servers on the driving path from the cloud server.

According to the generated server bridge, the link-server information is generated and then is transmitted to the second server constituting the server bridge and the vehicle, at step S1540.

According to the link-server information, the second server may set a server role. The second server may transmit the link-server information to a next server constituting the server bridge, at step S1550.

The vehicle receiving the link-server information may determine that the first server is set as the UL server, so that the first data is transmitted to the first server, at step S1560.

The first server receiving the first data processes the first data, according to the role of the UL server, at step S1570.

The second data that is the first data processing result may be transmitted through the first base station and the second base station to the second server that is a next server constituting the server bridge, at step S1580.

The second server may process the received second data according to the established role of the corresponding server, and the processing result may be transmitted to the next server constituting the server bridge, so that the server bridge may be operated and thereby the distributed processing of the first data is possible.

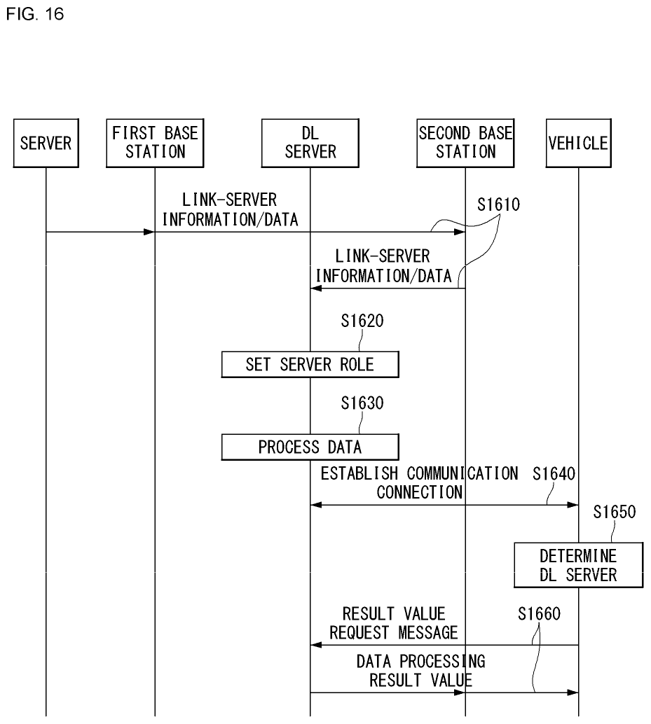

FIG. 16 illustrates an operation through the DL server to which the present disclosure is applicable.

Referring to FIG. 16, the vehicle may be connected through the second base station to the DL server. Here, the server means a server that is connected before the DL server in the server bridge for distributed-processing data received from the vehicle. The server and the DL server may be connected through the first base station and the second base station.

The server transmits the data processed through the server bridge and the link-server information of the server bridge, via the first base station and the second base station to the DL server at step S1610.

The DL server may set the corresponding server role, through the received link-server information at step S1620.

According to the set server role, the DL server processes the received data at step S1630.

If the vehicle is handed over to the second base station and communication connection with the DL server is established through the second base station, the vehicle may receive the link-server information from the DL server. Alternatively, the DL server may set the server role by transmitting the set information of the vehicle including link information to the DL server, at step S1640.

The vehicle may determine that the currently connected DL server is the DL server of the server bridge used by the vehicle, through the link-server information received from the DL server or the address information received from the DL server, at step S1650.

The vehicle transmits a message for requesting a data result value to the DL server. When the data has been processed, the DL server transmits the data processing result value to the vehicle at step S1660.

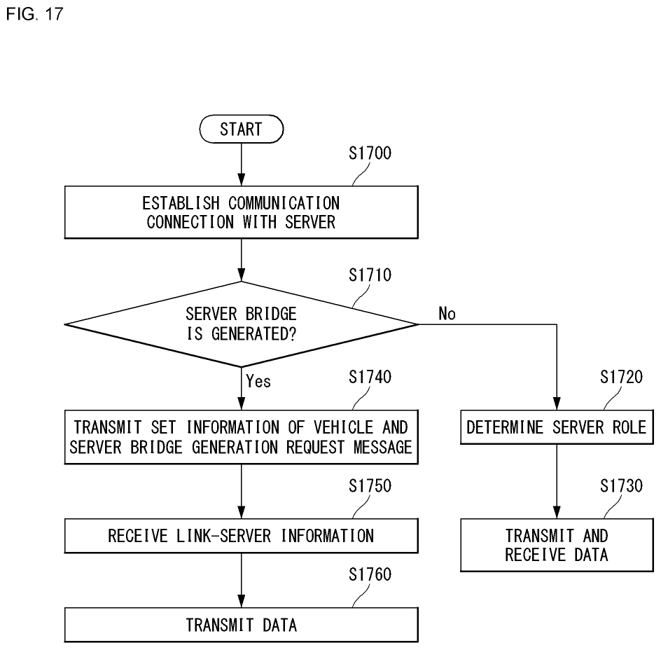

FIG. 17 illustrates the operation of the vehicle to which the present disclosure is applicable.

The vehicle may establish a communication connection with the server that is connected to the base station, via V2N communication, at step S1700.

The vehicle may automatically determine whether to generate the server bridge, on the basis of the size of data to be processed and the driving path, at step S1710. Alternatively, the generation of the server bridge may be required by a user's request.

If the generation of the server bridge is not required, the vehicle determines the server role of the connected server, at step S1720. To this end, the link-server information received from the server may be used, or the role of the connected server may be determined through the link-server information that is set in the vehicle.

The vehicle may transmit or receive data to or from the server, based on the server role, at step S1730. If the server is not a server constituting the server bridge, the server and the vehicle may transmit and receive the data to perform a common function for driving.

In the case of requiring the generation of the server bridge, the vehicle transmits the set information and the message requesting to generate the server bridge, at step S1740.

The server generates the server bridge, and transmits the link-server information including the information of the server constituting the server bridge to the vehicle, and the vehicle receives this information, at step S1750.

The vehicle transmits data that needs to be processed through the server bridge to the server, on the basis of the received link-server information, at step S1760.

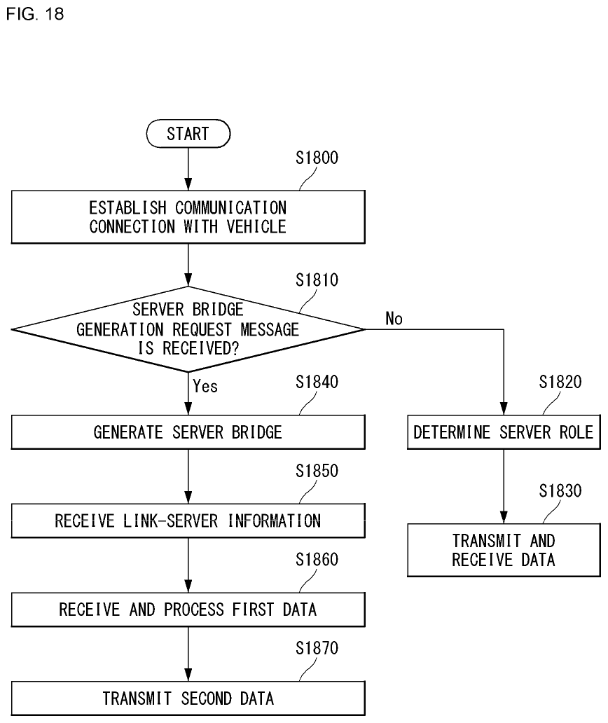

FIG. 18 illustrates the operation of the server to which the present disclosure is applicable.

The server establishes the communication connection with the vehicle through the base station, at step S1800. Thereby, the server may receive a set message or a request message for generating the server bridge from the vehicle.

The server determines whether the request message for generating the server bridge is received or not, at step S1830.

If the request message is not received, the server may determine its own server role, at step S1810. This may be determined on the basis of the link-server information received from the vehicle or another server.

The server transmits and receives data to and from the vehicle according to its own server role, at step S1820.

If the server receives the request message for generating the server bridge, the server generates the server bridge on the basis of the set information, at step S1840. Thereby, the server may be set as the UL server.

The server generating the server bridge transmits the link-server information including the information of servers constituting the server bridge, at step S1850.

The first data that needs to be processed through the server bridge from the vehicle is received, and the server processes the first data according to the set role, at step S1860.

The second data that is the processing result of the first data may be transmitted through the base station to the next server constituting the server bridge, at step S1870.

General Device to which the Present Disclosure is Applicable

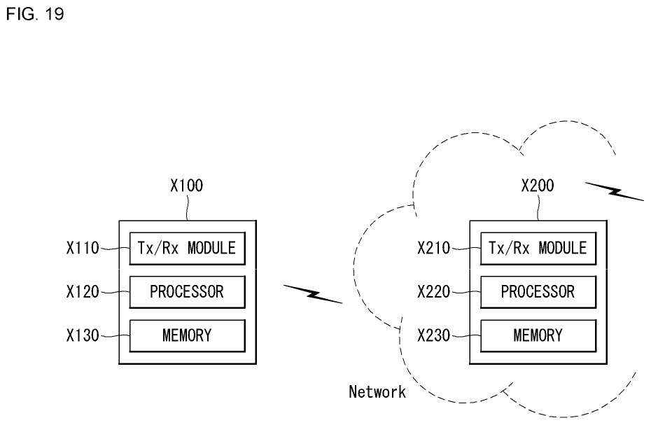

Referring to FIG. 19, a server X200 according to the proposed embodiment may be a MEC server or a cloud server, and may include a communication module X210, a processor X220, and a memory X230. The communication module X210 is referred to as a radio frequency (RF) unit. The communication module X210 may be configured to transmit various signals, data and information to an external device and to receive various signals, data and information from the external device. The server X200 may be connected to the external device with or without a wire. The communication module X210 may be implemented to be separated into a transmitter and a receiver. The processor X220 may control the whole operation of the server X200, and may be configured to perform the function of calculating information to be transmitted and received between the server X200 and the external device. Furthermore, the processor X220 may be configured to perform a server operation proposed in the present disclosure. The processor X220 may control the communication module X210 to transmit the data or the message to the UE, another vehicle or another server according to the present disclosure. The memory X230 may store the calculated information or the like for a predetermined period of time, and may be replaced with a component such as a buffer.

Furthermore, the above terminal device X100 and server X200 may be configured such that various embodiments of the present disclosure are independently applied or two or more embodiments are simultaneously applied, and a duplicated description will be omitted herein for the purpose of clarity.

### Embodiment 1

A method of setting a server bridge of a vehicle in an autonomous driving system, the method including:

establishing a communication connection with a first server through a first base station;

transmitting set information of the vehicle and a request message for generating the server bridge to the first server; and receiving address information of servers constituting the server bridge from the first server,

wherein the server bridge is composed of one or more servers for distributed processing first data generated by the vehicle, and connects a server performing an uplink for the vehicle with a server performing a downlink, and the set information includes driving path information of the vehicle and data information about a type and a size of the first data.

### Embodiment 2

The method of embodiment 1, further including:

transmitting the first data to the first server,

wherein the first server is set as a server for receiving the first data from the vehicle.

### Embodiment 3

The method of embodiment 2, further including:

establishing a communication connection with a second server, by handing over to a second base station; determining a server role of the second server, based on the server bridge;

and transmitting and receiving data to and from the second server, based on the server role.

### Embodiment 4

The method of embodiment 3, further including:

when the server has a role in transmitting the result value of the first data processed through the server bridge to the vehicle,

transmitting a message for requesting a result value to the second server; and receiving the result value.

### Embodiment 5

The method of embodiment 3, further including:

when the driving path information is reset,

transmitting the driving path information and a notification message notifying that the driving path information is reset to the second server; and receiving the updated address information.

### Embodiment 6

A method of setting a server bridge of a first server in an autonomous driving system, the method including:

establishing a communication connection with a vehicle in coverage of a first base station, through the first base station; receiving set information of the vehicle and a request message for generating the server bridge from the vehicle; setting as a server for receiving first data from the vehicle; determining an expected time for processing the first data, based on set information; generating the server bridge, based on the set information and the expected time; and transmitting address information of servers constituting the server bridge to the vehicle,

wherein the server bridge is composed of one or more servers for distributed processing the first data, and connects a server performing an uplink for the vehicle with a server performing a downlink, and the set information includes driving path information of the vehicle and data information on a type and a size of the first data.

### Embodiment 7

The method of embodiment 6, further including:

transmitting the address information to a second server that is a next component of the first server based on the server bridge, wherein the second server sets a server role based on the address information.

### Embodiment 8

The method of embodiment 7, further including:

receiving the first data from the vehicle;

structuring the first data; and transmitting the first data through the first base station to the second server,

wherein the structuring of the first data is to use a map reduce framework.

### Embodiment 9

The method of embodiment 8,

wherein, when the second server has a role in transmitting a result value of the first data processed through the server bridge to the vehicle,

the result value is transmitted through the second server to the vehicle.

### Embodiment 10

The method of embodiment 9,

wherein, when the driving path information is reset,

the driving path information and a notification message notifying that the driving path information is reset are received through the second server, the server bridge is regenerated based on the driving path information, the address information is updated based on the server bridge, and the address information is transmitted to the vehicle.

### Embodiment 11

The method of embodiment 7,

wherein the first server or the second server is a Mobile Edge Computing (MEC) server.

### Embodiment 12

The method of embodiment 6,

wherein the server bridge

includes an uplink (UL) server for receiving the first data from the vehicle, a processing server for processing the first data, or a downlink (DL) server for transmitting the result value of the first data.

### Embodiment 13

The method of embodiment 10,

wherein the reset server bridge

is based on a hardware specification or a processing speed of the server constituting the reset server bridge.

### Embodiment 14

The method of embodiment 12,

wherein each of the UL server and the processing server performs a role of a mapper for using the map reduce framework, and the DL server performs a role of a reducer for using the map reduce framework.

### Embodiment 15

A first server for performing a method of setting a server bridge in an autonomous driving system, the first server including:

a communication module; a memory; and a processor,

wherein the processor

establishes a communication connection with a vehicle in coverage of a first base station through the first base station using the communication module, receives set information of the vehicle and a request message for generating the server bridge from the vehicle, sets as a server for receiving first data from the vehicle, determines an expected time for processing the first data based on the set information, generates the server bridge based on the set information and the expected time, and transmits address information of servers constituting the server bridge to the vehicle using the communication module,

wherein the server bridge is composed of one or more servers for distributed processing the first data, and connects a server performing an uplink for the vehicle with a server performing a downlink, and the set information includes driving path information of the vehicle and data information on a type and a size of the first data.

### Embodiment 16

The first server of embodiment 15,

wherein the processor

transmits the address information through the communication module to the second server that is a next component of the first server, based on the server bridge, and the second server sets a server role based on the address information.

### Embodiment 17

The first server of embodiment 16,

wherein the processor

receives the first data from the vehicle, structures the first data, and transmits the first data through the first base station to the second server,

wherein the structuring is to use a map reduce framework.

### Embodiment 18

The first server of embodiment 17,

wherein, when the second server has a role in transmitting the result value of the first data processed through the server bridge to the vehicle,

the result value is transmitted through the second server to the vehicle.

### Embodiment 19

The first server of embodiment 18,

wherein, when the driving path information is reset,

the driving path information and a notification message notifying that the driving path information is reset are received through the second server, the server bridge is regenerated based on the driving path information, the address information is updated based on the server bridge, and the address information is transmitted to the vehicle.

### Embodiment 20

The first server of embodiment 16,

wherein the first server or the second server is a Mobile Edge Computing (MEC) server.

### Embodiment 21

The first server of embodiment 15,

wherein the server bridge

includes an uplink (UL) server for receiving the first data from the vehicle, a processing server for processing the first data, or a downlink (DL) server for transmitting the result value of the first data.

### Embodiment 22

The first server of embodiment 19,

wherein the reset server bridge

is based on a hardware specification or a processing speed of the server constituting the reset server bridge.

### Embodiment 23

The first server of embodiment 21,

wherein each of the UL server and the processing server performs a role of a mapper for using the map reduce framework, and the DL server performs a role of a reducer for using the map reduce framework.

The above-described invention may be embodied as a computer readable code on a medium on which a program is recorded. The computer readable medium includes all kinds of recording devices in which data that can be read by the computer system is stored. Examples of the computer readable medium include Hard Disk Drives (HDD), Solid State Disks (SSD), Silicon Disk Drives (SDD), ROMs, RAM,s CD-ROMs, magnetic tapes, floppy disks, optical data storing devices and others. Furthermore, the computer readable medium may be embodied in the form of a carrier wave (e.g. transmission via the Internet). Therefore, the above description is to be construed in all aspects as illustrative and not restrictive. The scope of the invention should be determined by the appended claims, and all changes coming within the meaning and equivalency range of the appended claims are intended to be embraced therein.

Although embodiments have been described with reference to a number of illustrative embodiments thereof, it should be understood that numerous other modifications and embodiments can be devised by those skilled in the art that will fall within the scope of the principles of this disclosure. For example, various variations and modifications are possible in components of the embodiments. It should be understood that various modifications, additions and substitutions are possible, without departing from the scope and spirit of the invention as disclosed in the accompanying claims.

Although the present disclosure has been described with reference to an example applied to automated vehicle and highway systems based on a 5 generation (5G) system, the invention may be applied to other wireless communication systems and autonomous driving devices.

What is claimed is:

1. A method of setting a server bridge of a vehicle in an autonomous driving system, the method comprising:
establishing a communication connection with a first server through a first base station;
transmitting set information of the vehicle and a request message for generating the server bridge to the first server; and
receiving address information of servers constituting the server bridge from the first server,
wherein the server bridge is composed of one or more servers for distributed processing first data generated by the vehicle, and connects a server performing an uplink for the vehicle with a server performing a downlink, and the set information comprises driving path information of the vehicle and data information about a type and a size of the first data.

2. The method of claim 1, further comprising:
transmitting the first data to the first server,
wherein the first server is set as a server for receiving the first data from the vehicle.

3. The method of claim 2, further comprising:
establishing a communication connection with a second server, by handing over to a second base station;
determining a server role of the second server, based on the server bridge; and
transmitting and receiving data to and from the second server, based on the server role.

4. The method of claim 3, further comprising:
when the server has a role in transmitting the result value of the first data processed through the server bridge to the vehicle,
transmitting a message for requesting a result value to the second server; and
receiving the result value.

5. The method of claim 3, further comprising:
when the driving path information is reset,
transmitting the driving path information and a notification message notifying that the driving path information is reset to the second server; and
receiving the updated address information.

6. A method of setting a server bridge of a first server in an autonomous driving system, the method comprising:
establishing a communication connection with a vehicle in coverage of a first base station, through the first base station;
receiving set information of the vehicle and a request message for generating the server bridge from the vehicle;
setting as a server for receiving first data from the vehicle;
determining an expected time for processing the first data, based on set information;
generating the server bridge, based on the set information and the expected time; and
transmitting address information of servers constituting the server bridge to the vehicle,
wherein the server bridge is composed of one or more servers for distributed processing the first data, and connects a server performing an uplink for the vehicle with a server performing a downlink, and the set information comprises driving path information of the vehicle and data information on a type and a size of the first data.

7. The method of claim 6, further comprising:
transmitting the address information to a second server that is a next component of the first server based on the server bridge,
wherein the second server sets a server role based on the address information.

8. The method of claim 7, further comprising:
receiving the first data from the vehicle;
structuring the first data; and
transmitting the first data through the first base station to the second server,
wherein the structuring of the first data is to use a map reduce framework.

9. The method of claim 8, wherein, when the second server has a role in transmitting a result value of the first data processed through the server bridge to the vehicle, the result value is transmitted through the second server to the vehicle.

10. The method of claim 9, wherein, when the driving path information is reset, the driving path information and a notification message notifying that the driving path information is reset are received through the second server, the server bridge is regenerated based on the driving path information, the address information is updated based on the server bridge, and the address information is transmitted to the vehicle.

11. The method of claim 7, wherein the first server or the second server is a Mobile Edge Computing (MEC) server.

12. The method of claim 6, wherein the server bridge comprises an uplink (UL) server for receiving the first data from the vehicle, a processing server for processing the first data, or a downlink (DL) server for transmitting the result value of the first data.

13. The method of claim 10, wherein the reset server bridge is based on a hardware specification or a processing speed of the server constituting the reset server bridge.

14. The method of claim 12, wherein each of the UL server and the processing server performs a role of a mapper for using the map reduce framework, and the DL server performs a role of a reducer for using the map reduce framework.

15. A first server for performing a method of setting a server bridge in an autonomous driving system, the first server comprising:
a transceiver;
a memory; and
a processor,
wherein the processor establishes a communication connection with a vehicle in coverage of a first base station through the first base station using the transceiver, receives set information of the vehicle and a request message for generating the server bridge from the vehicle, sets as a server for receiving first data from the vehicle, determines an expected time for processing the first data based on the set information, generates the server bridge based on the set information and the expected time, and transmits address information of servers constituting the server bridge to the vehicle using the transceiver,
wherein the server bridge is composed of one or more servers for distributed processing the first data, and connects a server performing an uplink for the vehicle with a server performing a downlink, and the set information comprises driving path information of the vehicle and data information on a type and a size of the first data.

16. The first server of claim 15, wherein the processor transmits the address information through the transceiver to the second server that is a next component of the first server, based on the server bridge, and
the second server sets a server role based on the address information.

17. The first server of claim 16, wherein the processor receives the first data from the vehicle, structures the first data, and transmits the first data through the first base station to the second server,
wherein the structuring is to use a map reduce framework.

18. The first server of claim 17, wherein, when the second server has a role in transmitting the result value of the first data processed through the server bridge to the vehicle, the result value is transmitted through the second server to the vehicle.

19. The first server of claim 18, wherein, when the driving path information is reset, the driving path information and a notification message notifying that the driving path information is reset are received through the second server, the server bridge is regenerated based on the driving path information, the address information is updated based on the server bridge, and the address information is transmitted to the vehicle.

20. The first server of claim 16, wherein the first server or the second server is a Mobile Edge Computing (MEC) server.
